(19) United States
(12) Patent Application Publication
(10) Pub. No.: US 2011/0085649 A1
(43) Pub. Date: Apr. 14, 2011

(54) Fluctuation Monitoring Method that Based on the Mid-Layer Data

(75) Inventors: JIUSONG SHAO, Nanjing (CN); ZHENHUA JI, Nanjing (CN); LIBIN SUN, Nanjing (CN); JIANQIANG DENG, Nanjing (CN); JINGLEI LANG, Nanjing (CN); DAWEI SHI, Nanjing (CN); YUFENG ZHAO, Nanjing (CN); ZHE HUANG, Nanjing (CN); SHUNCHENG XU, Nanjing (CN)

(73) Assignee: LINKAGE TECHNOLOGY GROUP CO., LTD., Nanjing (CN)

(21) Appl. No.: 12/901,814

(22) Filed: Oct. 11, 2010

(30) Foreign Application Priority Data
Oct. 12, 2009 (CN) 200910035852.3

(51) Int. Cl. H04M 15/00

(52) U.S. Cl. 379/133

(57) ABSTRACT

Fluctuation monitoring method based on the mid-layer data comprising a monitoring component of the customized instance, mid-layer telephone traffic statistics, a component of self learning telephone traffic and a drawing component of multidimensional traffic monitor. 1) Modeling of telephone traffic status is based on social science empirical model, and uses telephone traffic per day as an analysis granularity, which is composed of three dimensions—time, region and business. 2) the mid-layer of the telephone traffic statistics is calculated based on a monitoring target in regular time. 3) the self learning component of telephone traffic studies and forecasts based on monitoring data. 4) the drawing component of multidimensional traffic monitor will extract data from in the mid-layer of traffic data statistics.

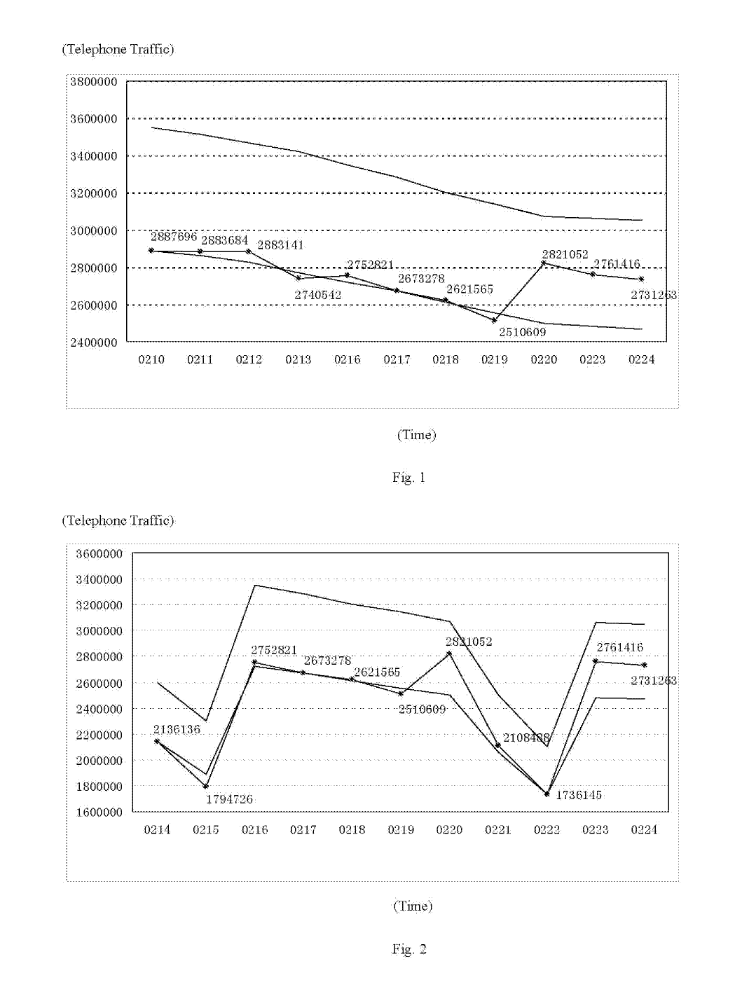

### CROSS REFERENCE TO RELATED PATENT APPLICATION

This patent application claims the priority of Chinese patent application No. 200910035852.3 filed on Oct. 12, 2009, which application is incorporated herein by reference.

### FIELD OF THE INVENTION

This invention is related to the technology of monitoring telephone traffic fluctuation, in particular with the technology of monitoring telephone traffic fluctuation with the self learning function over the telephone traffic.

### BACKGROUND OF THE INVENTION

A typical technology of monitoring telephone traffic is to set the traffic level within a specific period of time as a monitor granularity, and using the wave to determining the status of the telephone traffic by mapping out an oscillogram within consecutive period of time. The advantage of this method is that it can visually illustrate the traffic fluctuations over a period of time. However, due to the close relationship between level of telephone traffic and social activities, including a number of special social activities and periodical social activities, the telephone traffic could experience a significant change within consecutive sample period. Therefore, the disadvantage of the typical technology is it cannot automatically monitor and warning due to the shortage of an accurate abnormal threshold value. The traffic status is estimated by the traffic supervising staff and these staffs cannot ensure the accuracy of estimation. Because of the existence of some special changes and periodical changes, it's difficult to visually illustrate the overall trend of telephone traffic.

### SUMMARY OF THE INVENTION

The purpose of this invention: The existing technology is it cannot automatically monitor and warning due to the shortage of an accurate abnormal threshold value. The traffic status is estimated by the traffic supervising staff and these staffs cannot ensure the accuracy of estimation. Because of the existence of some special changes and periodical changes, it's difficult to visually illustrate the overall trend of telephone traffic. This invention provides a set of monitoring technology for telephone traffic in particular with the technology of monitoring traffic fluctuation with the self learning function over the telephone traffic, improve the monitoring accuracy by generating a multidimensional trend analysis diagram.

The technical solution of this invention: the setups for the monitoring component of the customized instance, the mid-layer telephone traffic statistics, component of self learning telephone traffic and the drawing component of multidimensional traffic monitor are based on the method of monitoring telephone traffic fluctuation in mid-layer of data;

1) The modeling of telephone traffic status is based on the social science empirical model, and uses the telephone traffic per day as an analysis granularity, which is composed of three dimensions—time, region and business. In customized component of monitoring instance, it chooses the region and business of a time sample point to conduct Cartesian product and then getting a series of monitoring instance that focus on each area and business. In each time sample point, the monitoring instance is corresponded to one monitoring granularity. It uses the instance as monitoring target and use the customized component of monitoring instance to set threshold floating ratio for monitoring instance.

2) The mid-layer of the telephone traffic statistics is calculated based on the monitoring target in regular time. The monitoring data will be saved and managed by the data statistical mid-layer.

3) The self learning component of telephone traffic studies and forecasts based on monitoring data, which is using moving average method of the seasonal time sequence to forecast the historical monitoring data, at the same time, saves the forecasted data in the mid-layer of telephone traffic data statistics. The predicted value and the threshold floating ration of the component of monitoring instance will be used to determine whether there is something abnormal in monitoring target.

4) The drawing component of multidimensional traffic monitor will extract data from in the mid-layer of traffic data statistics. It will illustrate the monitoring data and the predicted value that was obtained from the self learning component of telephone traffic from different time dimensions, and then generating the telephone traffic floating chart.

Further, it will set component with artificial audit for abnormal traffic and then artificially auditing the information by extracting the abnormal data within the mid-layer of traffic data statistic, at the same time, determining whether the aforementioned abnormal situation would affect the predication calculation within the self study component of the telephone traffic level.

Furthermore it will set three time features—working days, day off and holidays over the telephone traffic. After that, it will set the component of special instance management and categorized the holiday monitoring instance as the special instance, and working day and day off as the monitoring instance for studying and forecasting through the self learning component. The special instance is learnt and predicted through the special management component, and the method of studying and forecasting is same with the telephone traffic self learning component—Setting special instance threshold for special instance and using predicted value and special instance threshold value to determine whether monitoring target is normal or not.

The prediction of the telephone traffic status uses the moving average method under the self learning component of telephone traffic level within the same timeframe:

Choosing “N” recent accurate monitoring instance data to calculate the predicted value in the future, following is moving average method: Ft=(At-1+At-2+At-3+ . . . +At-n)/n, “Ft” is the predicted value for next monitor instance; “n” is the number of the monitoring instances of the moving average; “At-1” is actual monitoring data of the last monitoring instance; At-2, At-3 and At-n represent the last two, last three until the “pre-N” actual monitoring data of monitoring instance;

The customized instance component of monitoring sets threshold floating ratio as “k”. For a monitoring instance, the predicted value is t and the upper limit monitoring instance threshold is y1=t×(1+k), the lower limit is y2=t×(1−k). When this monitoring instance of the telephone traffic reaches “x” and satisfies the condition of “y1>x>y2”, the traffic level is normal; otherwise, it's abnormal.

Furthermore, the system sets the automatic alarming component of the abnormal telephone level, extract abnormal information from in the mid-layer of traffic data statistic, and eventually warn the monitoring target that was determined as abnormal target.

The benefit of this invention: The everyday prediction data of the telephone traffic, which is obtained by calculating the average level of the recent actual measurement, has the higher accuracy and correctly reflects trend of traffic change within recent period; System can automatically complete the self learning, monitoring and determination, thus making a warning for the abnormal results which solves the surveillance issues in the production process that exists in the past.

### BRIEF DESCRIPTION OF THE DRAWINGS

Diagram 1 is traffic fluctuation oscillogram which uses working day as time dimension. This is illustration “the same time feature” as the time dimension and shows that the rest group of time is steadily decreasing.

Diagram 2 is the traffic fluctuation oscillogram which uses the normal working day as time dimension. This is illustration “the normal time feature” as the time dimension and shows a cyclical changing pattern with five times high and twice low.

### DETAIL DESCRIPTION OF THE INVENTION

This invention set the following component: the monitoring component of the customized instance, the mid-layer telephone traffic statistics, component of self learning telephone traffic, special instance management component, abnormal traffic artificial audit component, the drawing component of multidimensional traffic monitor and the abnormal traffic automatic warning component.

The modeling component of the customized instance can either be generated by each individual dimension's Cartesian production or artificially setting the monitor target through the customized instance of this component.

The mid-layer telephone traffic obtain the data from the monitor target's data in the customized monitoring process and then the calculated statistics will be saved and managed by the mid-layer of the traffics system.

The self learning component of telephone traffic studies and forecasts based on monitoring data, which is using moving average method of the seasonal time sequence to forecast the historical monitoring data, at the same time, saves the forecasted data in the mid-layer of telephone traffic data statistics. The predicted value and the threshold floating ration of the component of monitoring instance will be used to determine whether there is something abnormal in monitoring target.

Special instance management component is the supplementary of traffic self learning component. It specializes on managing the monitoring on special dates and special traffic level, and the method of studying and forecasting is same with the telephone traffic self learning component—Setting special instance threshold for special instance and using predicted value and special instance threshold value to determine whether monitoring target is normal or not.

Abnormal traffic artificial audit component is used for determining the abnormal traffic instance, which are all of the monitoring instances that were not in the threshold range that was estimated by the traffic self learning component—abnormal information. This component will determine whether the abnormal information is practical and then determine whether it will be used for the prediction value calculation of the traffic self learning component.

The drawing component of multidimensional traffic will extract data from in the mid-layer of traffic data statistics from different dimensions, illustrate the prediction value from the monitoring data and traffic self study component, and eventually generating the oscillogram.

The abnormal traffic automatic warning component provides monitor warning information for user. It extracts abnormal information of traffic data statistics in mid-layer and warns the abnormal monitoring target.

As traffic status within telecom industry is closely related to society, it usually adopts empirical model of social science to modeling. It uses a day's telephone traffic as an analysis granularity and the granularity has three dimensional features: time, region and business. The whole study objective is a 3-D cube that is composed of these three features. In the customized component of monitoring instance, choosing region and business to process Cartesian production and then get a series of monitoring instance that focus on each region and business. In each of sampling time point, one monitoring instance corresponds to one monitoring granularity. The traffic data in mid-layer will get statistics from the monitoring target in regular time and the statistical data has following rules: After modeling a specific region with a particular business by following time serial, the model has seasonal characteristics. Actually, the telephone traffic is largely affected by three time dimensions—working day, day off and holiday. The length of the holiday is influenced by national policy and the time pattern is relatively unstable and long—usually for a year. Therefore, in order to manager this type of day, these dates will be categorized into a special threshold value to manage, and studied and forecasted by the special instance management component; the rest monitoring data could be studied and forecasted by the traffic self learning component.

Within the two special time frames—working day and day off, the traffic status shows weekly cyclical changing pattern. Within the cyclical change, Monday to Friday is stable; Saturdays and Sundays are two special values respectively, and they usually change within number of cyclic period; working days, Saturday and Sundays are separate stable sequences. There are many calculation methods that specializing on such seasonal time frame model: the traffic self studying uses the average calculation under the self learning component within the same timeframe. The simple moving average method is the following: Ft=(At-1+At-2+At-3+ . . . +At-n)/n, “Ft” is the predicted value for next monitor instance; “n” is the number of the monitoring instances of the moving average method; “At-1” is actual monitoring data of the last monitoring instance; At-2, At-3 and At-n represent the last two, last three until the “pre-N” actual monitoring data of monitoring instance; The customized instance component of monitoring sets threshold floating ratio as “k”. For a monitoring instance, the predicted value is t and the upper limit monitoring instance threshold is y1=t×(1+k), the lower limit is y2=t×(1−k). When this monitoring instance of the telephone traffic reaches “x” and satisfies the condition of “y1>x>y2”, the traffic level is normal; otherwise, it's abnormal.

Artificial audit component extract and audit these abnormal information. At the same time the abnormal traffic automatically warning component extracts abnormal information and then make warning. The staff can check and get the statistic and forecast result through multidimensional traffic monitor drawing part in accordance with series of “same time” and the “natural time” Use a monitoring granularity as the example, the invention achieved the following process:

1) Choosing the monitoring dimensions within the monitoring instance customization component and generate the monitoring instance;

2) Get the statistics in accordance with the monitoring instance in the traffic statistical mid-layer in the regular time;

3) Traffic self learning component analysis monitoring instances in accordance with the time characteristics and using the moving average method to calculate the predicted values. According to the threshold set to determine the status of monitoring instance, and update the traffic data statistics in mid-layer. If the instance is special, it will be updated through the special instance management system;

4) Abnormal traffic artificial audit component will check traffic data statistics in mid-layer, and then make warning to abnormal monitoring instance;

5) The staff will get the traffic fluctuation oscillogram from the drawing component of multidimensional traffic monitor, and the staff will analyze the reason of the existing abnormal traffic through abnormal traffic artificial audit component. By using the component, it will help the staff to determine whether the abnormal information is practical or not. It will then determine whether the abnormal information will get involved within the prediction value calculation of the traffic self learning component. It is the signal of the effectiveness of setting monitoring instance.

Diagram 1 is traffic fluctuation oscillogram which uses working day as time dimension. This is illustration “the same time feature” as the time dimension and shows that the rest group of time is steadily decreasing. Diagram 2 is the traffic fluctuation oscillogram which uses the normal working day as time dimension. This is illustration “the normal time feature” as the time dimension and shows a cyclical changing pattern with five times high and twice low.

Setting the traffic monitoring process of Guangzhou conversation voice service as an example, the implementation method is below:
1. Setting monitoring instance through adding a record in the monitoring instance configuration list. The record is below: region (Guangzhou), Business (Network conversation);
2. Traffic statistics in mid-layer will count the traffic of the monitoring instance, the task program will automatically record the telephone traffic of the day which is 300,000;
3. The system will determine the monitoring instance which is not in the area of special instance management, the traffic self learning component will begin to estimate the telephone traffic level;
4. Assume monitoring date is Sunday, and set 10 as the length of simply moving average method. The total number of traffic before these 10 Sundays is 15 million. Thus based on the formula of simple average calculation method, the prediction value is 1.5 million. When the threshold value is set as 5%, it could determine the upper limit of the day's threshold value is 1,500,000×(1+5%), and the lower limit is 1,500,000×(1−5%). Because 300,000 is not in the range of threshold value, therefore it will be determined as abnormal. The front system will generate the warning message and the instance status will be signaled as auditing pending.
5. The monitoring staff will generate the traffic fluctuation diagram in the front desk.
6. The staff will then audit the monitoring instance. If the auditor pass the instance and the instance is abnormal indeed, the abnormal signal will be edited and waiting for the next prediction calculation; otherwise, the instance is not valid and will not get involved in the next prediction value calculation.

The parameter of the above process can be configured beforehand and it normally does not need to be modified. All monitoring process will be automatically completed by internal components and the staff only needs to audit the abnormal instance.

1. A system of monitoring telephone traffic fluctuation in mid-layer of data comprising:
a monitoring component of the customized instance, mid-layer telephone traffic statistics, a component of self learning telephone traffic and a drawing component of multidimensional traffic monitor;
1) modeling of telephone traffic status is based on social science empirical model, and uses telephone traffic per day as an analysis granularity, which is composed of three dimensions—time, region and business; in customized component of monitoring instance, it chooses region and business of a time sample point to conduct Cartesian product and then getting a series of monitoring instance that focus on each area and business; in each time sample point, monitoring instance is corresponded to one monitoring granularity; it uses the instance as monitoring target and uses the customized component of monitoring instance to set threshold floating ratio for monitoring instance;
2) the mid-layer of the telephone traffic statistics is calculated based on a monitoring target in regular time, monitoring data will be saved and managed by the data statistical mid-layer.
3) the self learning component of telephone traffic studies and forecasts based on monitoring data, which is using moving average method of the seasonal time sequence to forecast historical monitoring data, at the same time, saves the forecasted data in the mid-layer of telephone traffic data statistics; a predicted value and a threshold floating ration of the component of monitoring instance will be used to determine whether there is something abnormal in monitoring target.
4) the drawing component of multidimensional traffic monitor will extract data from in the mid-layer of traffic data statistics, it will illustrate monitoring data and predicted value that was obtained from the self learning component of telephone traffic from different time dimensions, and then generating the telephone traffic floating chart.

2. The system of monitoring telephone traffic fluctuation in mid-layer of data of claim 1, wherein setting component with artificial audit for abnormal traffic and then artificially auditing the information by extracting the abnormal data within the mid-layer of traffic data statistic, at the same time, determining whether the abnormal situation would affect the predication calculation within the self study component of the telephone traffic level.

3. The system of monitoring telephone traffic fluctuation in mid-layer of claim 1 wherein setting three time features—working days, day off and holidays over the telephone traffic, after that, it will set component of special instance management and categorize holiday monitoring instance as the special instance, and working day and day off as the monitoring instance for studying and forecasting through the self learning component, the special instance is learnt and forecasted through the special management component, and the method of studying and forecasting is same with the telephone traffic self learning component—setting special instance threshold for special instance and using predicted value and special instance threshold value to determine whether monitoring target is normal or not.

4. The system of monitoring telephone traffic fluctuation in mid-layer of claim 1, wherein predicting the telephone traffic by using a moving average method under the self learning component of telephone traffic level within the same timeframe:
choosing “N” recent accurate monitoring instance data to calculate the predicted value in the future, following is moving average method: Ft=(At-1+At-2+At-3+ . . . +At-n)/n, “Ft” is the predicted value for next monitor instance; “n” is the number of the monitoring instances of the moving average method; “At-1” is actual monitoring data of the last monitoring instance; At-2, At-3 and At-n represent the last two, last three until the “pre-N” actual monitoring data of monitoring instance;
the customized instance component of monitoring sets threshold floating ratio as “k”. For a monitoring instance, the predicted value is t and the upper limit monitoring instance threshold is y1=t×(1+k), the lower limit is y2=t×(1−k). When this monitoring instance of the telephone traffic reaches “x” and satisfies the condition of “y1>x>y2”, the traffic level is normal; otherwise, it's abnormal.

5. The system of monitoring telephone traffic fluctuation in mid-layer of claim 1, wherein predicting the telephone traffic by using the average calculation under the self learning component of telephone traffic level within the same timeframe:
choosing “N” recent accurate monitoring instance data to calculate the predicted value in the future, following is moving average method: Ft=(At-1+At-2+At-3+ . . . +At-n)/n, “Ft” is the predicted value for next monitor instance; “n” is the number of the monitoring instances of the movement average calculation; “At-1” is actual monitoring data of the last monitoring instance; At-2, At-3 and At-n represent the last two, last three until the “pre-N” actual monitoring data of monitoring instance;
the customized instance component of monitoring sets threshold floating ratio as “K”. For a monitoring instance, the predicted value is t and the upper limit monitoring instance threshold is y1=t×(1+k), the lower limit is y2=t×(1−k). When this monitoring instance of the telephone traffic reaches “x” and satisfies the condition of “y1>x>y2”, the traffic level is normal; otherwise, it's abnormal.

6. The system of monitoring telephone traffic fluctuation in mid-layer of claim 1, wherein to set the automatic alarming component of the abnormal telephone level, extract abnormal information from in the mid-layer of traffic data statistic, and eventually warn the monitoring target that was determined as abnormal target.

7. The system of monitoring telephone traffic fluctuation in mid-layer of claim 3, wherein to set the automatic alarming component of the abnormal telephone level, extract abnormal information from in the mid-layer of traffic data statistic, and eventually warn the monitoring target that was determined as abnormal target.

8. The system of monitoring telephone traffic fluctuation in mid-layer of claim 4, wherein to set the automatic alarming component of the abnormal telephone level, extract abnormal information from in the mid-layer of traffic data statistic, and eventually warn the monitoring target that was determined as abnormal target.

9. The system of monitoring telephone traffic fluctuation in mid-layer of claim 5, wherein to set the automatic alarming component of the abnormal telephone level, extract abnormal information from in the mid-layer of traffic data statistic, and eventually warn the monitoring target that was determined as abnormal target.

10. The system of monitoring telephone traffic fluctuation in mid-layer of claim 2 wherein setting three time features—working days, day off and holidays over the telephone traffic, after that, it will set component of special instance management and categorize holiday monitoring instance as the special instance, and working day and day off as the monitoring instance for studying and forecasting through the self learning component, the special instance is learnt and forecasted through the special management component, and the method of studying and forecasting is same with the telephone traffic self learning component—setting special instance threshold for special instance and using predicted value and special instance threshold value to determine whether monitoring target is normal or not.

11. The system of monitoring telephone traffic fluctuation in mid-layer of claim 2, wherein predicting the telephone traffic by using a moving average method under the self learning component of telephone traffic level within the same timeframe:
choosing “N” recent accurate monitoring instance data to calculate the predicted value in the future, following is moving average method: Ft=(At-1+At-2+At-3+ . . . +At-n)/n, “Ft” is the predicted value for next monitor instance; “n” is the number of the monitoring instances of the moving average method; “At-1” is actual monitoring data of the last monitoring instance; At-2, At-3 and At-n represent the last two, last three until the “pre-N” actual monitoring data of monitoring instance;
the customized instance component of monitoring sets threshold floating ratio as “k”. For a monitoring instance, the predicted value is t and the upper limit monitoring instance threshold is y1=t×(1+k) , the lower limit is y2=t×(1−k). When this monitoring instance of the telephone traffic reaches “x” and satisfies the condition of “y1>x>y2”, the traffic level is normal; otherwise, it's abnormal.

12. The system of monitoring telephone traffic fluctuation in mid-layer of claim 2, wherein predicting the telephone traffic by using the average calculation under the self learning component of telephone traffic level within the same timeframe:
choosing “N” recent accurate monitoring instance data to calculate the predicted value in the future, following is moving average method: Ft=(At-1+At-2+At-3+ . . . +At-n)/n, “Ft” is the predicted value for next monitor instance; “n” is the number of the monitoring instances of the movement average calculation; “At-1” is actual monitoring data of the last monitoring instance; At-2, At-3 and At-n represent the last two, last three until the “pre-N” actual monitoring data of monitoring instance;
the customized instance component of monitoring sets threshold floating ratio as “K”. For a monitoring instance, the predicted value is t and the upper limit monitoring instance threshold is y1=t×(1+k), the lower limit is y2=t×(1−k). When this monitoring instance of the telephone traffic reaches “x” and satisfies the condition of “y1>x>y2”, the traffic level is normal; otherwise, it's abnormal.

13. The system of monitoring telephone traffic fluctuation in mid-layer of claim 2, wherein to set the automatic alarming component of the abnormal telephone level, extract abnormal information from in the mid-layer of traffic data statistic, and eventually warn the monitoring target that was determined as abnormal target.

14. The system of monitoring telephone traffic fluctuation in mid-layer of claim 10, wherein to set the automatic alarming component of the abnormal telephone level, extract abnormal information from in the mid-layer of traffic data statistic, and eventually warn the monitoring target that was determined as abnormal target.

15. The system of monitoring telephone traffic fluctuation in mid-layer of claim 11, wherein to set the automatic alarming component of the abnormal telephone level, extract abnormal information from in the mid-layer of traffic data statistic, and eventually warn the monitoring target that was determined as abnormal target.

16. The system of monitoring telephone traffic fluctuation in mid-layer of claim 12, wherein to set the automatic alarming component of the abnormal telephone level, extract abnormal information from in the mid-layer of traffic data statistic, and eventually warn the monitoring target that was determined as abnormal target.
